(19) United States
(12) Patent Application Publication
(10) Pub. No.: US 2016/0003720 A1
(43) Pub. Date: Jan. 7, 2016

(54) Apparatus Comprising an Increased-Capacity Platinumware Holder and Method Therefor

(71) Applicant: SPEX Sample Prep LLC, Metuchen, NJ (US)

(72) Inventors: Neil Stein, Sea Girt, NJ (US); Ralph Obenauf, Basking Ridge, NJ (US); Marc Boivin, Quebec (CA); Pierre-Emmanuel LeMay, Quebec (CA)

(21) Appl. No.: 14/330,511

(22) Filed: Jul. 14, 2014

Related U.S. Application Data
(60) Provisional application No. 62/021,653, filed on Jul. 7, 2014.

(51) Int. Cl. G01N 1/44; B29C 31/02; B29C 37/00; B29C 33/30

(52) U.S. Cl. CPC G01N 1/44; B29C 33/30; B29C 31/02; B29C 37/0053; B29L 2031/40

(57) ABSTRACT

A platinumware holder includes a crucible holder in which the crucibles are laterally staggered and a mold rack in which the molds are vertically staggered. In some embodiments, the crucibles have a non-circular cross section.

### STATEMENT OF RELATED CASES

This case claims priority to U.S. Pat. Application Ser. No. 62/021,653 filed on Jul. 7, 2014 and incorporated by reference herein.

### FIELD OF THE INVENTION

The present invention relates in general to the preparation of inorganic samples by fusion, and more particularly to equipment for doing so.

### BACKGROUND

Analyzing an inorganic sample via analytical techniques such as x-ray fluorescence (XRF), inductively coupled plasma (ICP), atomic absorption (AA) requires that the sample be specially prepared before analysis. The sample must often be in the form of a solid, smooth-surface shape, such as that of a disk or bead. In this form, the sample does not exhibit mineralogical, grain-size, or orientation effects that might otherwise skew the analytical results.

A process known as “fusion” can be used to prepare samples for XRF, ICP, and AA. During this process, a powered sample is dissolved into a solvent, typically a lithium borate flux. The flux is solid at room temperature and therefore must be liquefied. As a consequence, the fusion process is conducted in a furnace/oven, sometimes called a “fluxer”.

To prepare a sample, a precise amount of ground sample and flux, along with a small amount of a non-wetting agent, are added to a platinum crucible and placed in a fluxer. Upon heating, the flux melts and dissolves the sample. Dissolution is enhanced by agitating the platinum crucible. The sample itself never actually melts; it is merely dissolved into the liquefied flux. The non-wetting agent prevents the melted flux from sticking to the crucible.

After complete dissolution, the molten solution is poured into a plate-shaped platinum mold that is also placed in the fluxer. Upon cooling, a small, homogeneous glass-like disk or bead of sample results.

The temperature of the fusion process can reach 1200° C., which poses significant challenges to the durability of the materials and parts used. Many applications require a plurality of crucibles and molds to be heated simultaneously, which adds to the challenge, as larger furnaces result in increased heat losses.

The crucibles are heated to process temperature via a gas flame (models by Corporation Scientifique Claisse, XRF Scientific, HD Elektronik and others), in an electrical induction furnace (models by Herzog, and formerly by PANalytical) or in electrical resistive furnaces (models by Katanax, Corporation Scientifique Claisse, XRF Scientific and others).

Furnaces that accommodate multiple crucibles typically arrange the crucibles and molds in linear configurations, as illustrated in FIGS. 1 and 2. FIG. 1 depicts a prior-art crucible holder 100 and crucibles 114, as used in some resistive-heated furnaces available from Katanax, Inc. of Quebéc, Canada. Crucible holder 100 includes support beam 102, spacers 104, retaining beams 106, and brackets 108, arranged and interrelated as shown.

FIG. 2 depicts prior-art mold rack 200 and molds 224, as used in some resistive-heated furnaces available from Katanax, Inc. Mold rack 200 includes support beams 214, mold retainers 216, spacers 218, brackets 220, and end supports 222, arranged and interrelated as shown.

In use, crucible holder 100 is disposed above molder holder 200. Crucible holder is supported so as to be rotatable about its longitudinal axis (i.e., an axis that aligns with the two end supports 110). Crucibles 112 and molds 224 are situated to align with one another so that hot solution poured from each crucible 112 is received by a respective mold 224.

For a facility that analyzes samples via XRF, ICP, or AA, if the analytical demand increases such that more samples must be prepared for analysis, there are primarily two courses of action. One is to purchase one or more additional fluxers. But fluxers are expensive and, of course, additional fluxers will consume extra bench space. The second course of action is to replace an existing smaller-capacity fluxer with a larger-capacity unit. A relatively larger capacity fluxer will have relatively larger furnace inner-chamber dimensions to accommodate the increasingly elongated linear arrays of crucibles and molds. The increase in furnace size results in increased power consumption and increases the bench space or floor area required to accommodate it. Additionally, as the linear array of crucibles lengthens, the mechanical stress on the correspondingly longer crucible holder increases significantly.

Thus, it would be very desirable to be able to increase fluxer throughput without altering the size of the crucible holder or furnace inner chamber.

### SUMMARY

The invention provides a way to increase the throughput of a fluxer without increasing its size. This is accomplished, in the illustrative embodiment, by a novel arrangement of crucibles (in the crucible holder) and molds (in the mold rack).

In some embodiments, the crucibles and molds are organized in staggered rows within their holders/racks (hereinafter collectively “platinumware holder” for use in this disclosure and the appended claims). The result of this staggered arrangement is that more crucibles and molds can then be accommodated in a holder/rack of a given length.

In developing the novel arrangement of crucibles and molds, the inventors had to address the following issues, in addition to any others:
to work within the limitations imposed by the available high-temperature materials;
to enable the back row of crucibles to have a different pouring motion than the front row;
to maintain a single pouring/rocking axis;
to permit proper locking of both rows of crucibles;
to keep a relatively similar net pouring height for all paired crucibles and molds; and
to fit molds up to the maximum size commercially used.

In the illustrative embodiment, the crucibles are laterally staggered but not vertically staggered in the crucible holder and the molds are vertically staggered but not laterally staggered in the mold rack.

In some further embodiments, the crucibles are laterally staggered and vertically staggered and the molds are vertically staggered but not laterally staggered. In some additional embodiments, the crucibles are laterally staggered but not vertically staggered and the molds are vertically staggered and laterally staggered. In still further embodiments, the crucibles are laterally staggered and vertically staggered in the crucible holder and the molds are vertically staggered and laterally staggered in the mold rack. The ability to vertically stagger the crucibles is a function of, among any other considerations, the manner in which the crucibles are retained in the crucible holder. The ability to laterally stagger the molds is a function of, among any other considerations, the size of the molds relative to the size of the furnace inner chamber.

In some further embodiments, the crucibles can be manufactured to have a cross-sectional geometry that is different than the nominal circular shape of existing crucibles. This enables the crucibles to be positioned closer to one another; that is, to increase the “fill factor,” thereby making it possible to accommodate more crucibles by a crucible holder of a given length.

### BRIEF DESCRIPTION OF THE DRAWINGS

FIG. 1 depicts a perspective view of a crucible holder in the prior art.

FIG. 2 depicts a perspective view of a mold rack in the prior art.

FIG. 3 depicts a perspective view of a platinumware holder in accordance with the illustrative embodiment of the present invention.

FIG. 4A depicts a simplified plan view of the crucible holder of FIG. 3.

FIG. 4B depicts a simplified front view of the mold rack of FIG. 3.

FIG. 5 depicts a first alternative embodiment of a crucible for use in conjunction with embodiments of the invention.

FIG. 6 depicts a second alternative embodiment of a crucible for use in conjunction with embodiments of the invention.

FIG. 7 depicts a third alternative embodiment of a crucible for use in conjunction with embodiments of the invention.

FIG. 8 depicts a fourth alternative embodiment of a crucible for use in conjunction with embodiments of the invention.

FIG. 9 depicts a linear array of the crucible of FIG. 5.

FIG. 10 depicts an illustration of pouring angle α.

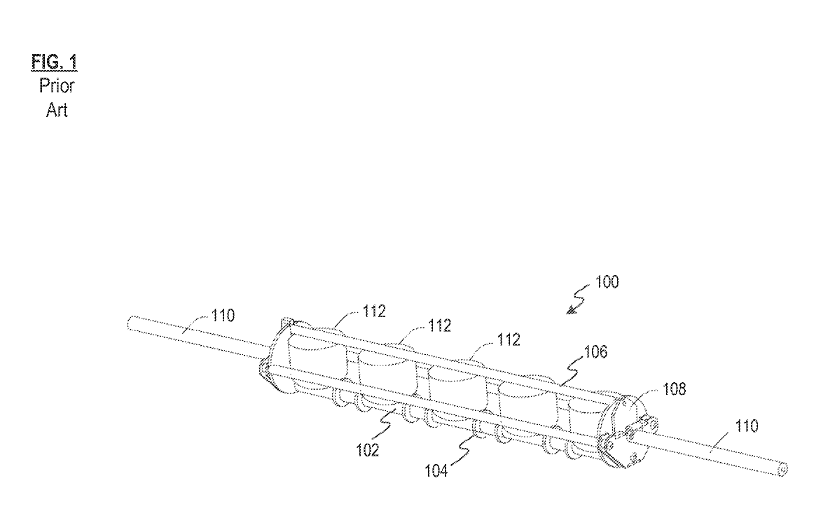

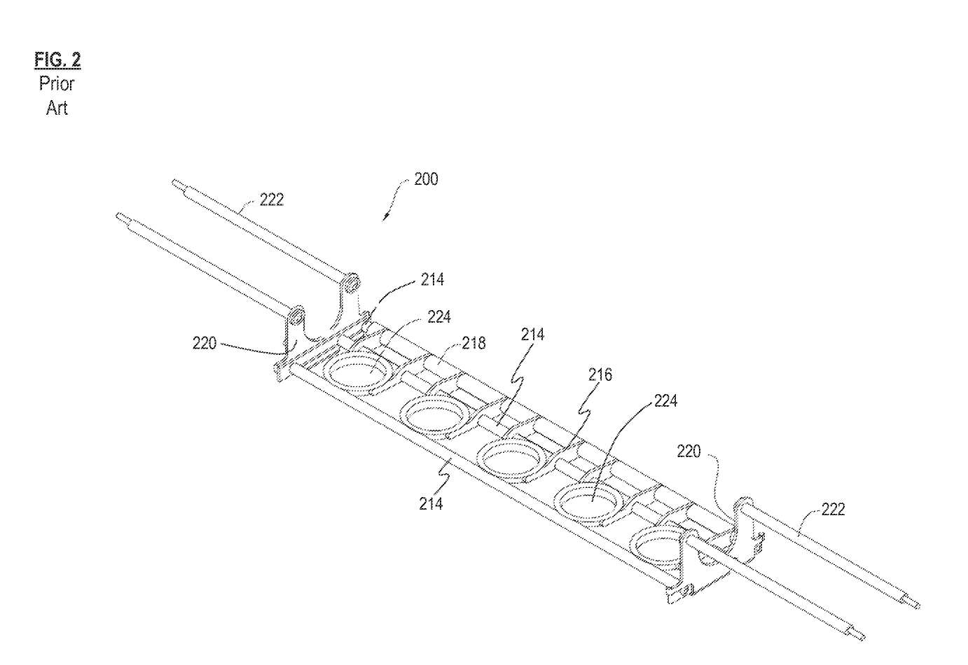

### DETAILED DESCRIPTION

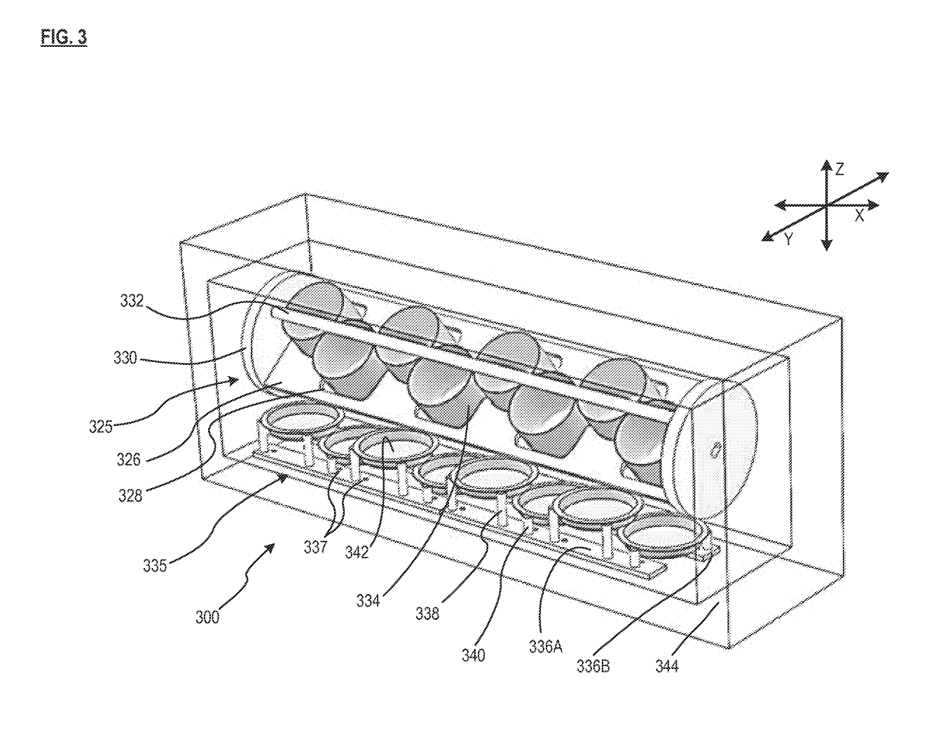

FIG. 3 depicts platinumware holder 300, including crucible holder 325 and mold rack 335, in accordance with the illustrative embodiment of the present invention. Crucible holder 325 supports crucibles 334 and mold rack 335 supports molds 342.

In FIG. 3, platinumware holder 300 is depicted within furnace inner chamber 344. The platinumware holder is arranged to slide in and out of furnace inner chamber 344 via an appropriate mechanism, not depicted, the design of which is within the capabilities of those skilled in the art. See, e.g., http://www.katanax.com/cgi/show.cgi?products/K2prime/K2primevideo.l=en.html. Furthermore, the aforementioned mechanism is suitable for supporting crucible holder 325 above mold rack 335 and enabling the crucible holder to partially rotate so that the molten solution from crucibles 334 can be poured into molds 342.

Crucible holder 325 includes base plate 326, end portions 330, and retaining beam 332, interrelated as shown. In some embodiments, retaining beam 332 is a ceramic material and base plate 326 and end portions 330 comprise silicon nitride. In some other embodiments, base plate 326, end portions 330, retaining beam 332 all comprise silicon nitride. In yet some further embodiments, these elements can be fabricated from other suitable materials, as known to those skilled in the art.

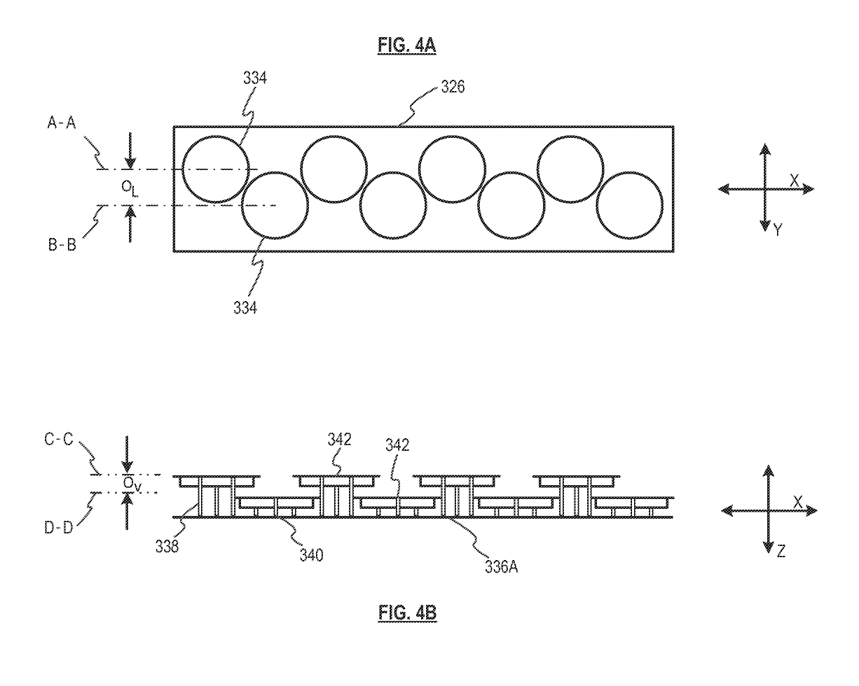

Base plate 326 includes plural openings 328 that receive respective plural crucibles 334. Openings 328 seat crucibles 334 and dictate their positioning in crucible holder 325. As depicted in FIG. 4A, adjacent openings 328 are laterally offset from one another defining two laterally offset rows of crucibles. A back row of crucibles 334 aligns with axis A-A, which passes through the center of the crucibles in that row. A front row of crucibles 334 aligns with axis B-B, which passes through the center of the crucibles in that row. The two axes, and hence the two rows of crucibles, have lateral offset O_{L}. In this context, “lateral” means “along the ‘y’ direction,” as that axis is defined in FIG. 4A.

In some other embodiments, base plate 326 does not include openings 328. Such other embodiments include alternative features, such as retaining tabs, etc., which provide the functionality of openings 328 (i.e., immobilizing and positioning). Similar to openings 328, such alternative features are positioned to form two laterally offset rows of crucibles 334. The design and use of such alternative features are within the capabilities of those skilled in the art in conjunction with the present disclosure.

Referring again to FIG. 3, mold rack 335 includes support beams 336A and 336B, first standoffs 338, and second standoffs 340. In some embodiments, support beams 336, first standoffs 338, and second standoffs 340 all comprise silicon nitride. In some further embodiments, these elements can be fabricated from other suitable materials, as known to those skilled in the art.

Support beams 336A and 336B includes holes 337 for receiving the standoffs 338 and 340. The unused holes 337 depicted in FIG. 3 provide an ability to accommodate smaller diameter molds than those used in the illustrative embodiment. This provides mold rack 335 with an ability to accept virtually all commerically-used molds.

First standoffs 338 are longer than second standoffs 340. In the illustrative embodiment, three same-length standoffs are used to support each mold 342. For a given mold being supported, two of the three standoffs are disposed on one of support beams 336A or 336B, and the third is disposed on the other of the support beams 336B or 336A.

Thus, three of first standoffs 338 are used to support a mold 342 at a first height and three of second standoffs 340 are used to support a mold 342 at a second height, the first height being higher than the second height.

Referring now to FIG. 4B as well as FIG. 3, first standoffs 338 and second standoffs 340 alternate on support beams 336A and 336B. More particularly, in the illustrative embodiment, two first standoffs 338 alternate with a single second standoff 340 on support beam 336A. Conversely, on support beam 336B, a single first standoff 338 alternates with two second standoffs 340. As a consequence of this alternating arrangement, adjacent molds 342 are supported at different heights. In particular, molds 342 that are supported by first standoffs 338 are supported at the first height, as defined by axis C-C, defining a higher row of molds. Molds 342 that are supported by second standoffs 340 are supported at the second height, as defined by axis D-D, defining a lower row of molds. The two axes, and hence the two rows of molds, have a vertical offset O_{V}. As discussed later in this specification, the size of offset O_{V} is dependent on lateral offset O_{L}.

In some other embodiments, rather than using standoffs, a different feature is used to position molds 342. The design and use of such alternative features are within the capabilities of those skilled in the art in conjunction with the present disclosure.

With reference to FIG. 3, it is apparent that crucibles 334 in the back row will pour their contents from a height that is greater than the height at which crucibles 334 in the front row pour their contents. As used in this disclosure and the appended claims, the phrase “pour height” means the height from which the molten solution falls as it leaves a crucible.

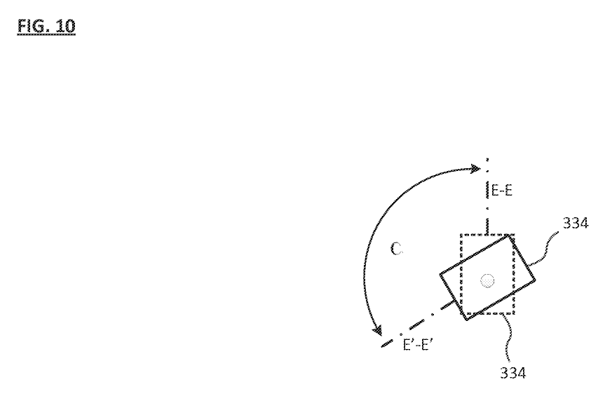

It is desirable that the net pour height is the same for each crucible-mold pairing. As used in this disclosure and the appended claims, the phrase “net pour height” means the distance that the molten solution falls from a crucible to a mold. Since net pour height is desirably the same for all pairings, a mold that is paired with a crucible in the back row (having a relatively higher pour height) should be in the higher row of molds and a mold that is paired with a crucible in the front row (having a relatively lower pour height) should be in the lower row of molds. Standoffs 338 and 340 are positioned along support beams 336A and 336B to satisfy this constraint. As used in this disclosure and the appended claims, the term “align” and its inflected forms, when referencing the relative positioning of a paired crucible and mold, means a position that enables the mold to receive hot solution from the paired crucible when the crucible holder is rotated to pour its contents. And the term “paired”, when referring to a relationship between a crucible and a mold, means that the crucible and the mold are aligned. As used in this disclosure and the appended claims, the phrase “pouring angle” means the angle subtended between the axial/longitudinal axis E-E of crucible 334 when it is vertically oriented and the axial/longitudinal axis E′-E′ of crucible 334 when it has assumed its final tilted position for pouring the molten liquid into the molds. (See FIG. 10 for a simplified illustration of pouring angle.)

Ideally, the relatively greater height of molds 342 in the higher row should exactly compensate for the greater pouring height of crucibles 334 in the back row so that regardless of whether the crucible is located in the back row or the front row, the net pouring height is the same. The pour height (and net pour height) changes as the crucibles are rotated to pour their contents. Assuming that the level of solution in the crucible is relatively low compared to the height of the crucible (c.a., about 20 percent or less), such that only minimal solution flows out of the crucible by the time it is rotated to a horizontal position, it is appropriate to calculate the net pour height based on the final tilted position of the crucibles. The difference in pour height ApH between the two rows of crucibles is:

Δ_{PH}=O_{L}·sin α [1]

### Where:

ΔPH is the difference in pour height between the two rows;
O_{L} is the lateral offset between rows of crucibles; and
α is the pouring angle.

For example, assuming that the pouring angle is 135 degrees, the difference in pour height as a consequence of the lateral offset is:

Δ_{PH}=O_{L}·sin (135°)=0.7O_{L} [2]

Assuming, for example, that the lateral offset O_{L} is 15 millimeters (mm), the difference in pour height at the pouring angle is:

Δ_{PH}=0.7O_{L}=0.7×15 mm=10.5 mm [3]

In such an example, the higher row of molds would therefore ideally be situated 10.5 mm higher than the lower row of molds.

It is not necessary that the pour heights be the same for all crucible/mold pairs. In this context, variations greater than 50% in net pour height between the back row of crucibles (and their paired molds) and the front row crucibles (and their paired molds) is acceptable, a variation of +/−50% or less in net pour height is preferred, a variation of +/−25% or less is more preferred, and a variation of +/−15% or less is most preferred. As used in this disclosure and the appended claims, the term “substantially” or “about”, such as in the context of “substantially equal” or “about equal,” means within +/−15% of “equal”.

Lateral offset O_{L} dictates the number of crucibles that can fit in a crucible holder of a given length. But typically, that number is ultimately limited by the number of molds that can fit in a mold rack.

### EXAMPLE

Most mold racks are designed to accommodate 6 of the largest molds currently in use in the industry, which have a 51 mm outer-rim diameter. Hence, current mold racks are slightly larger than 6×51=306 mm. Arranging the molds into two vertically offset arrays of molds in accordance with the present teachings requires there to be a gap between adjacent molds in the higher row (to be able to pour liquid into the molds in the lower row). Preferably, the gap between adjacent molds in the top row should be at least about 10 mm to reduce the possibility that the molten flow from a front-row crucible hits an upper-row mold on either side of the gap. As a consequence, the distance from the leading edge of a first mold to the leading edge of the adjacent mold is:

51 mm+10 mm=61 mm [4]

With an available width of 306 mm, the maximum number of molds in the top row is:

306 mm/61 mm≈5 molds [5]

By virtue of the four gaps between the 5 molds in the upper row, 4 molds can be situated in the lower row, for a maximum theoretical total of 9 molds. Therefore, a practical maximum number of crucibles is 9, regardless of whether more can fit in the space available. (Since a typical crucible diameter is 41 mm, more than 9 crucibles can fit in the space available in the crucible holder for this Example via a staggered arrangement.) For a crucible holder of the same size as the mold rack, it was found that staggering 9 crucibles resulted in an unacceptable amount of stagger; that is, too much lateral offset. In particular, at the moment of pouring (when the crucible rack has rotated), there is a reasonable likelihood that the molten flux poured from back-row crucibles will contact retaining beam 332 (FIG. 3). As a consequence, in this Example, 8 crucibles and 8 molds are used for a furnace that accepts a 306 mm crucible holder and 306 mm mold rack. This represents a 33.3 percent increase in fluxer capacity (8 versus 6) without increasing the size of the furnace.

As an alternative to the laterally staggered crucibles, a crucible with a non-circular cross section can be used. In some cases, crucibles having non-circular geometries can be more tightly packed together, thereby enabling more crucibles to fit in a crucible holder of a given length.

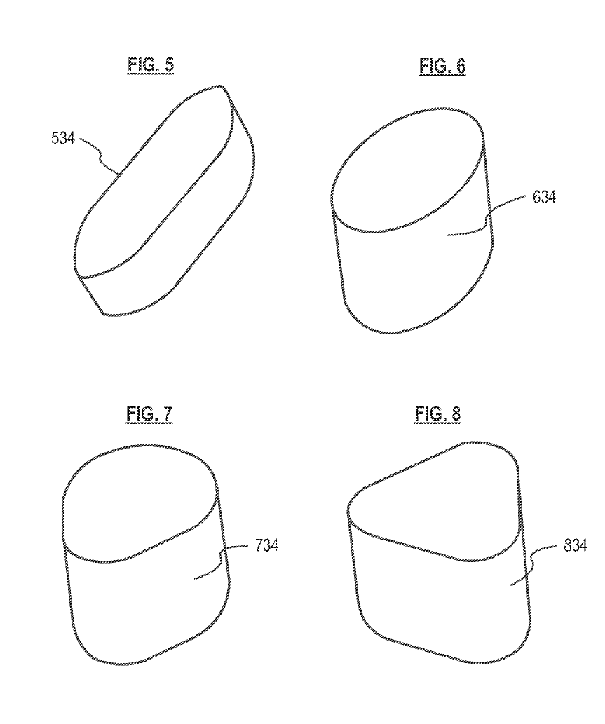

FIGS. 5 through 8 depict several alternative crucible geometries. FIG. 5 depicts canoe-shaped crucible 534. FIG. 6 depicts oblong-shaped crucible 634. FIG. 7 depicts teardrop-shaped crucible 734. FIG. 8 depicts triangular-shaped crucible 834. Crucibles having a racetrack shape, an oblong shape, a teardrop shape, and a triangular shape can be positioned more closely to one another than crucibles having a cylindrical shape, such as those depicted in FIG. 3.

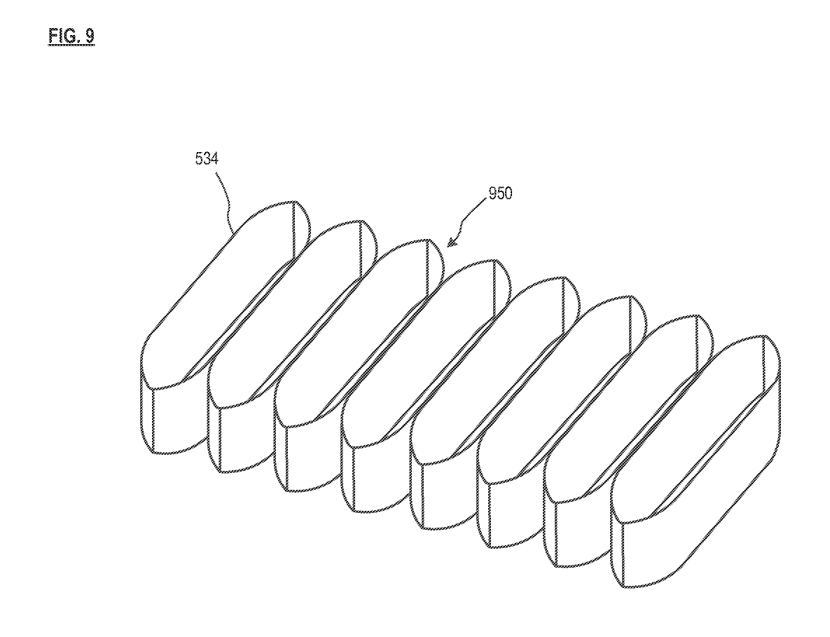

FIG. 9 depicts array 950 of canoe-shaped crucibles 534. In embodiments in which a single linear array of crucibles is used, an array such as array 950 will include more crucibles than would be possible using conventional crucibles with a circular cross-section. Although not depicted in array 950, crucibles 534 might require staggering to achieve an acceptably consistent pour height, since the molds will be vertically offset, as depicted in FIG. 3.

It is to be understood that the disclosure describes a few embodiments and that many variations of the invention can easily be devised by those skilled in the art after reading this disclosure and that the scope of the present invention is to be determined by the following claims. For example, although a staggered arrangement was used in the illustrative embodiment to increase the number of crucibles/molds from 6 to 8, in other embodiments, it is used to increase the capacity of smaller holders/rack (e.g., increasing a nominal 3-crucible holder/3-mold rack to 5+crucibles and 5+molds, etc.). In other words, the staggered arrangements disclosed herein can be used to increase the capacity of any size crucible holder and mold rack.

What is claimed:

1. An apparatus comprising a platinumware holder, wherein the platinumware holder comprises:
a crucible holder that is physically adapted to receive a plurality of crucibles in a staggered arrangement defining two laterally offset rows of crucibles; and
a mold rack that is physically adapted to receive a plurality of molds in a staggered arrangement defining two vertically offset rows of molds.

2. The apparatus of claim 1 wherein the crucible holder includes a base plate, wherein the base plate comprises a plurality of openings for receiving the plurality of crucibles, wherein adjacent openings are laterally offset.

3. The apparatus of claim 1 wherein the crucible holder is partially rotatable about a longitudinal axis thereof.

4. The apparatus of claim 3 wherein the crucible holder includes a single retaining beam, wherein the retaining beam is arranged to prevent the plurality of crucibles from dislodging when the crucible holder is partially rotated.

5. The apparatus of claim 1 wherein the crucible holder comprises silicon nitride.

6. The apparatus of claim 1 wherein the mold rack comprises:
a first plurality of standoffs that extend vertically to a first height for supporting some of the molds of the plurality thereof; and
a second plurality of standoffs that extend vertically to a second height for supporting the molds not supported by the first plurality of standoffs, wherein the first height is greater than the second height, and wherein a difference between the first height and the second height defines a vertical offset of the two vertically offset rows of molds.

7. The apparatus of claim 6 wherein the two laterally offset rows include a back row of crucibles and a front row of crucibles, wherein the back row falls along a first axis and the front row falls along a second axis, and wherein:
(a) a distance between the first axis and the second axis defines a lateral offset of the two laterally offset rows of crucibles; and
(b) the first plurality of standoffs are positioned to align molds with the back row of crucibles and the second plurality of standoffs are positioned to align molds with the front row of crucibles.

8. The apparatus of claim 7 wherein the vertical offset is a function of the lateral offset.

9. The apparatus of claim 7 wherein the vertical offset is substantially equal to a difference between a pour height of the back row of crucibles and a pour height of the front row of crucibles.

10. The apparatus of claim 7 wherein the vertical offset is substantially equal to the lateral offset multiplied by the sine of the crucible holder's pouring angle.

11. The apparatus of claim 1 wherein the plurality of crucibles comprises eight crucibles.

12. The apparatus of claim 11 wherein the plurality of molds comprises eight molds.

13. The apparatus of claim 1 wherein the apparatus is a fluxer.

14. The apparatus of claim 1 further comprising the plurality of crucibles and a plurality of molds.

15. The apparatus of claim 1 wherein adjacent molds are at two different heights.

16. The apparatus of claim 1 wherein the crucibles have a non-circular cross section.

17. The apparatus of claim 1 wherein the crucibles have a race track-shaped cross section.

18. An apparatus comprising a platinumware holder, wherein the platinumware holder comprises:
a crucible holder that is physically adapted to receive a plurality of crucibles in a staggered arrangement defining two rows of crucibles having a lateral offset; and
a mold rack that is physically adapted to receive a plurality of molds in a staggered arrangement defining two rows of molds having a vertical offset but not a lateral offset, wherein the vertical offset is based on the lateral offset.

19. The apparatus of claim 18 wherein the apparatus is a fluxer.

20. The apparatus of claim 19 further comprising the crucibles and the molds.

21. A method for arranging crucibles and molds in a platinumware holder, comprising:
forming a first row of crucibles along a first direction in a crucible holder of the platinumware holder;
forming a second row of crucibles along the first direction in the crucible holder, wherein the first row of crucibles and the second row of crucibles are laterally offset from one another;
forming a first row of molds along the first direction in a mold rack of the platinumware holder; and
forming a second row of molds along the second direction in the mold rack, wherein the first row of crucibles and the second row of crucibles are vertically offset from one another.
